(19) United States
(12) Patent Application Publication
(10) Pub. No.: US 2010/0078912 A1
(43) Pub. Date: Apr. 1, 2010

(54) Bicycle Trailer

(76) Inventors: Lee-Rong Chang, Kaohsiung City (TW); Meng-Kuei Chou, Fongshan City (TW); Jung-Hui Weng, Kaohsiung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/242,972

(22) Filed: Oct. 1, 2008

(51) Int. Cl. B62K 27/00; B62D 63/06; B62K 27/12

(52) U.S. Cl. 280/204

(57) ABSTRACT

The bicycle trailer in accordance with an aspect of the present invention includes a carrying frame, two adjusting modules and two wheels. The carrying frame is adapted to hold objects. The adjusting modules mounted at two opposite sides of the carrying frame respectively. Each adjusting module includes a pivoting member pivotably coupled to an corner of the carrying frame, an adjusting member movably mounted on the carrying frame to move close to or away from the pivoting member and a connecting bar with two ends thereof respectively fixed to the adjusting member and one end of the pivoting member. The two wheels are coupled to the other ends of the pivoting members of the two adjusting modules respectively. Consequently, positions of the wheels relative to the carrying frame are adjustable through the adjusting modules, so that the bicycle trailer can be adapted as a baggage barrow when separated from a bicycle.

### BACKGROUND OF THE INVENTION

1. Field of the Invention

The present invention relatives to a trailer and, more particularly, to a bicycle trailer can be adapted as a baggage barrow when separated from a bicycle.

2. Description of the Related Art

A conventional bicycle trailer includes a carrier that is selected from a case or a frame made of plural rods for holding objects like goods or baggage, two wheels separately mounted at two lateral sides and near the rear of the carrier, and a connecting member with one end thereof coupled to the front of the carrier. A free end of the connecting member is adapted to be coupled to a bicycle, such that the trailer and the bicycle are linked. In use, the front of the carrier linked to the bicycle through the connecting member is away from the ground without contact. Hence, the carrier of the conventional bicycle trailer can be pulled behind the bicycle to move along a road with the wheels turning.

Nevertheless, said conventional bicycle trailer has several drawbacks. For example, a position of the carrier relative to the ground is fixed and can't be adjusted according to a user's need in different situations, so that the conventional bicycle trailer only provides a use for transportation by bicycles. Thus, inconvenience of using the conventional bicycle trailer is provided. Besides, if the position of the carrier relative to the ground is too low, the carrier will easily hit rocks and break while the conventional bicycle trailer is moving. On the other hand, if the position of the carrier relative to the ground is too high, the conventional bicycle trailer will overturn easily because of its highly disposed center-of-gravity position. Hence, there is a need for an improvement over the conventional bicycle trailer.

### SUMMARY OF THE INVENTION

It is therefore the primary objective of this invention to provide a bicycle trailer that overcomes the problems of the prior art described above to allow the bicycle trailer to be used as a baggage barrow when separated from bicycle.

The secondary objective of this invention is to provide the bicycle trailer that can avoid damage thereof by adjusting positions of wheels of the bicycle trailer.

The bicycle trailer in accordance with an aspect of the present invention includes a carrying frame, two adjusting modules and two wheels. The carrying frame is adapted to receivehold objects. The adjusting modules mounted at two opposite sides of the carrying frame respectively. Each adjusting module includes a pivoting member pivotably coupled to an corner of the carrying frame, an adjusting member movably mounted on the carrying frame and aligned with the pivoting member to move close to or away from the pivoting member and a connecting bar with two ends thereof respectively fixed to the adjusting member and one end of the pivoting member. The two wheels are coupled to the other ends of the pivoting members of the two adjusting modules respectively. Consequently, positions of the wheels relative to the carrying frame are adjustable through the adjusting modules, and this make the bicycle trailer to have several different uses.

In an example, the pivoting member is an L-shaped arm with a bent portion thereof forming a combining portion and has a first end and a second end, with each combining portion being coupled to the corner of the carrying frame, with both first ends being fixed to the connecting bars and both second ends being fixed to axial centers of the two wheels. Accordingly, the wheels can be driven to move by turning of the pivoting members.

In an example, the adjusting member has a movable seat movably mounted on a rod of the carrying frame, with the rods where the movable seats of the two adjusting modules mounted being at the two opposite sides of the carrying frame, and a positioning element combing with the movable seat to fix the movable seat at a position on the rod of the carrying frame, with the other end of the connecting bar being fixed to the movable seat. Accordingly, the movable seat can be positioned close to or away from the pivoting member and the pivoting member can be driven to turn by horizontal movement of the movable seat, so that positions of the wheels relative to the carrying frame can be adjusted.

In an example, the bicycle trailer further includes a linking arm coupled to the carrying frame, with the linking arm being at the front side of the carrying frame and the wheels being at the back side of the carrying frame. Accordingly, the bicycle trailer can be linked to a bicycle through the linking arm.

In an example, the linking arm is a bent rod corresponding to the contour of the carrying frame and the linking arm has a linking portion on one end thereof which is adapted to be coupled to the bicycle. Accordingly, the linking portion can be engaged with the bicycle while the linking arm will not contact with parts of the bicycle.

In an example, the bicycle trailer further includes a fastening module mounted between the linking arm and the carrying frame, with the linking arm being pivotably coupled to the carrying frame through the fastening module. Accordingly, the linking arm can be easily lapped over the carrying frame or not.

In an example, the fastening module has a plurality of rings with each of which forming a flange and a pin, with two adjacent rings being mounted around the carrying frame and the linking arm respectively, with flanges of the two adjacent rings being aligned with and attached to each other, with the pin extending through the attached flanges. Accordingly, the linking arm and the carrying frame are reliably combined and the linking arm is able to pivot on the pin.

In an example, the fastening module further has a clasping element rotatably mounted on one end of the linking arm adjacent to the carrying frame, with the clasping element having a clasping portion selected from a C-loop which can engage with the carrying frame or not. Accordingly, a secure combination between the linking arm and the carrying frame is provided.

In an example, the bicycle trailer further includes a connector with two ends thereof fixed to the movable seats of the adjusting modules respectively. Accordingly, the movable seats can move synchronously.

In an example, the bicycle trailer further includes two shock absorbers with each of them mounted on the connecting bar. Accordingly, shock impulse is dampened.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view illustrating a bicycle trailer in accordance with a first embodiment of the present invention;

FIG. 2 is another perspective view illustrating the bicycle trailer in accordance with the first embodiment of the present invention;

FIG. 3 is a lateral view illustrating the bicycle trailer of FIG. 2;

FIG. 4 is a perspective view illustrating the bicycle trailer of FIG. 2 coupled to a wheel;

FIG. 5 is an enlarged detailed side view illustrating a adjusting module and a wheel of the bicycle trailer in accordance with the first embodiment of the present invention;

FIG. 6 is another enlarged detailed side view illustrating the adjusting module and the wheel of the bicycle trailer in accordance with the first embodiment of the present invention;

FIG. 7 is a perspective view illustrating the bicycle trailer in a storing state for putting it away;

FIG. 8 is a lateral view illustrating a user pulling the bicycle trailer of FIG. 7; and

FIG. 9 is a lateral view illustrating a bicycle trailer in accordance with a second embodiment of the present invention.

In the various figures of the drawings, the same numerals designate the same or similar parts. Furthermore, when the terms “first”, “second”, “end”, “axial”, “portion”, “horizontal”, “colockwise” and similar terms are used hereinafter, it should be understood that these terms are reference only to the structure shown in the drawings as it would appear to a person viewing the drawings and are utilized only to facilitate describing the invention.

### DETAILED DESCRIPTION OF THE INVENTION

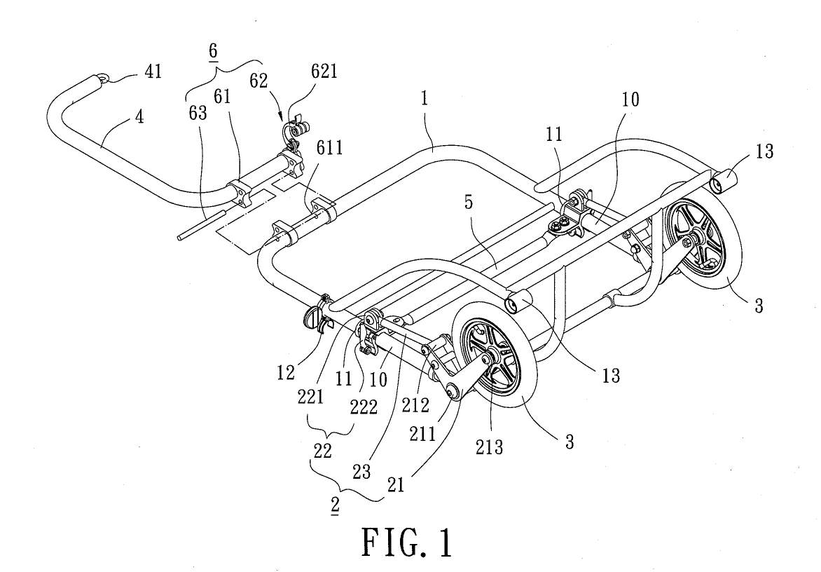

Referring initially to FIGS. 1 to 3, a perspective view of a bicycle trailer of a first embodiment according to the preferred teachings of the present invention is illustrated. The bicycle trailer includes a carrying frame 1 having a plurality of rods integrally or not for holding objects like goods or baggage, two adjusting modules 2 mounted at two opposite sides of the carrying frame 1 respectively, two wheels 3 disposed at the same two opposite sides of the carrying frame 1 through the adjusting modules 2, and a linking arm 4. Each of the adjusting modules 2 includes a pivoting member 21 pivotably coupled to an corner of the carrying frame 1, an adjusting member 22 and a connecting bar 23 disposed between the pivoting member 21 and the adjusting member 22. The pivoting member 21 is preferable an L-shaped arm having an angle ranging 60° to 150°, with a bent portion of the L-shaped arm forming a combining portion 211 and the pivoting member 21 having a first end 212 and a second end 213. The combining portion 211 between the first end 212 and the second end 213 is coupled to the corner of the carrying frame 1, so that the pivoting member 21 can pivot on a position where the combining portion 211 and the carrying frame 1 combine.

The adjusting member 22 has a movable seat 221 and a positioning element 222. The movable seats 221 of the two adjusting modules 2 are respectively movably mounted on two rods 10 of the carrying frame 1, with the two rods 10 being at the two opposite sides of the carrying frame 1, and each movable seat 221 is aligned with the pivoting member 21 to move close to or away from the pivoting member 21. The positioning element 222 combines with the movable seat 221 to fix the movable seat 221 at a predetermined position on the rod 10 of the carrying frame 1. In this embodiment, the positioning element 222 is able to clamp the rod 10 of the carrying frame 1 to position the movable seat 221. Two ends of the connecting bar 23 are fixed to the first end 212 of the pivoting member 21 and the movable seat 221 of the adjusting member 22 respectively to link the pivoting member 21 and the adjusting member 22. Furthermore, there are two retaining blocks 11 respectively disposed on the rods 10 of the carrying frame 1 where the adjusting members 22 of the two adjusting modules 2 are mounted, with the adjusting member 22 being between each retaining block 11 and the pivoting member 21. Hence, a distance of the movable seat 221 moving along the rod 10 of the carrying frame 1 is limited by each of the retaining blocks 11. Besides, there is a connector 5 with two ends thereof fixed to the movable seats 221 of the adjusting modules 2 respectively, such that the movable seats 221 can synchronously move along the rods 10 of the carrying frame 1.

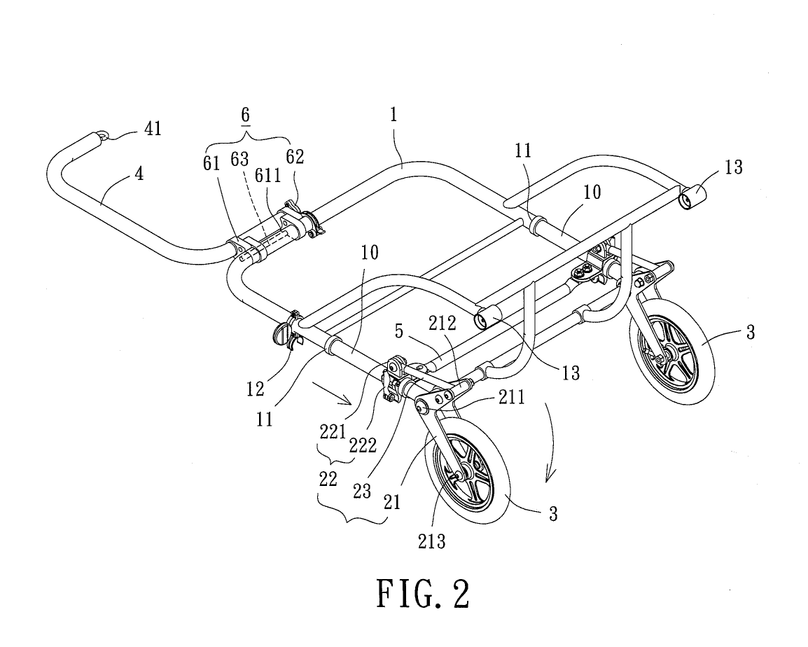

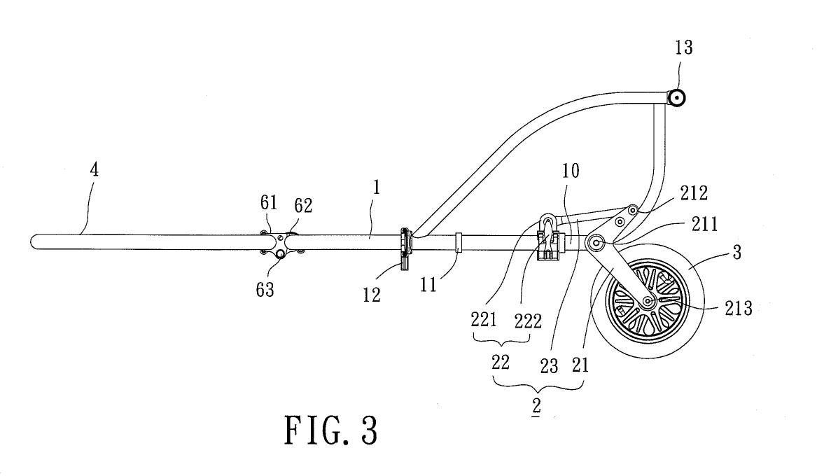

Still referring to FIGS. 1 to 3, an axial center of each wheel 3 is coupled to the second end 213 of the pivoting member 21, such that the movable seat 221 is able to move each wheel 3 via the pivoting member 21. In detail, as shown in FIG. 2, while each movable seat 221 moves towards each pivoting member 21, the pivoting member 21 is pushed to turn clockwise via the connecting bar 23, such that the wheels 3 coupled to the pivoting members 21 are driven to move. Therefore, positions of the wheels 3 relative to the carrying frame 1 are adjusted to change a distance between the carrying frame 1 and the ground (see FIG. 3).

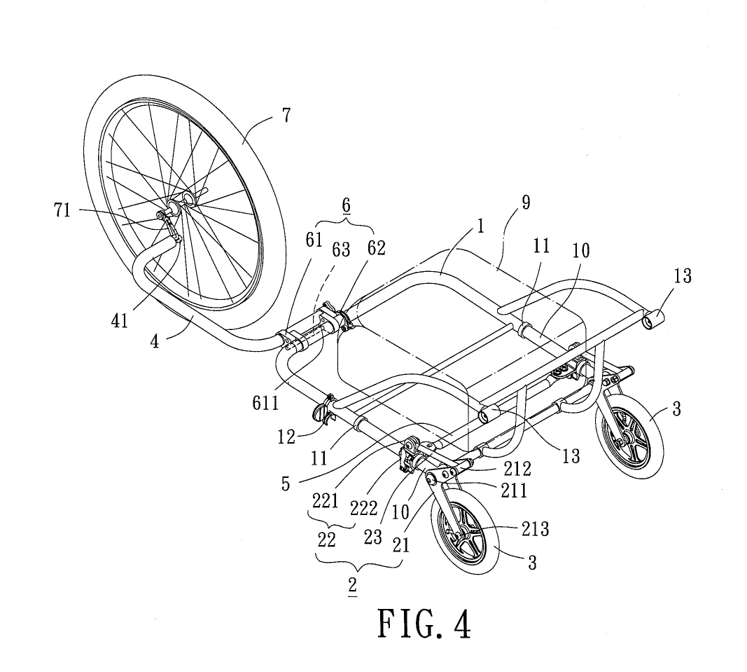

The linking arm 4 has a linking portion 41 on one end thereof, with the linking portion 41 being preferred a ring, a hook or the like. The linking arm 4 close to the other end thereof is combined with a rod of the carrying frame 1 through a fastening module 6, with the linking arm 4 and the wheels 3 being at the front side and the back side of the carrying frame 1 respectively. Furthermore, the fastening module 6 is mounted between the linking arm 4 close to the other end thereof and the rod of the carrying frame 1 to couple them. And the fastening module 6 has a plurality of rings 61 and a clasping element 62, with each ring 61 forming a flange 611. The two adjacent rings 61 are mounted around the carrying frame 1 and the linking arm 4 respectively, with flanges 611 of the two adjacent rings 61 being aligned with and attached to each other. A pin 63 extends through the attached flanges 611 to complete combination of the carrying frame 1 and the linking arm 4, so that the linking arm 4 can pivot on the pin 63. The clasping element 62 is rotatably mounted on the other end of the linking arm 4 without the linking portion 41, and the clasping element 62 has a clasping portion 621, which is preferred a C-loop and can be engaged with the carrying frame 1 to fix a position of the linking arm 4 relative to the carrying frame 1, or not engaged with the carrying frame 1 when the linking arm 4 pivots on the pin 63. Hence, a secure combination between the linking arm 4 and the carrying frame 1 is provided. Besides, the linking arm 4 is preferred a bent rod corresponding to the contour of the carrying frame 1, so that the linking arm 4 will not contact with a rear wheel 7 or other parts of a bicycle when the linking arm 4 is coupled to the bicycle (see FIG. 4), and it's easy to put the bicycle trailer of the present invention away when it is not used.

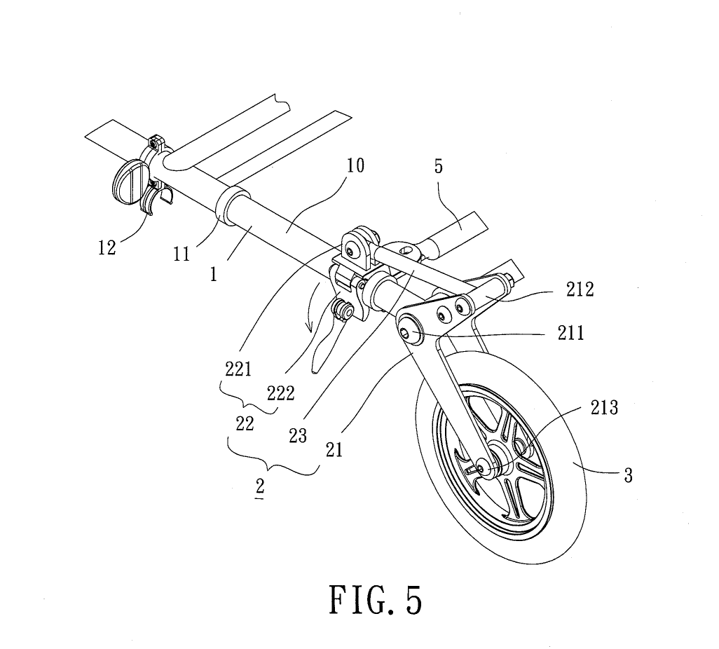

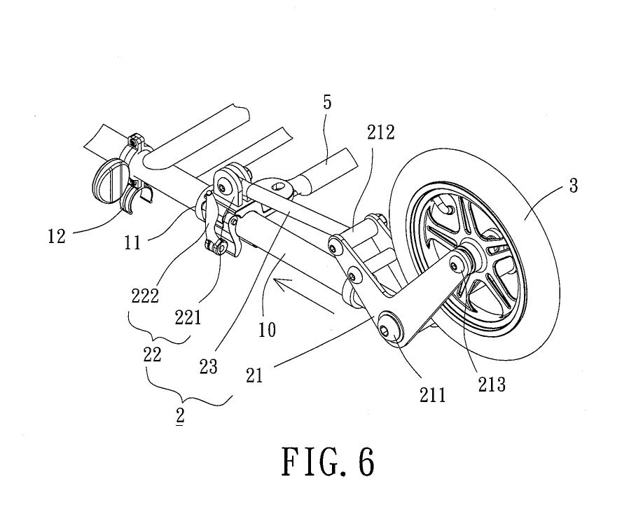

Referring now to FIG. 4, in use, the linking portion 41 of the linking arm 4 and an engaging hook 71 fixed on the rear wheel 7 are coupled together to connect the bicycle trailer of the present invention and the bicycle, such that the bicycle trailer can be pulled to move by and after the bicycle to transport a baggage 9 received on the carrying frame 1. Moreover, a position of the carrying frame 1 relative to the ground can be adjusted according to rough unevenness in surface of roads. For example, referring to FIGS. 5 and 6, when lowering the position of the carrying frame 1 relative to the ground is necessary, each positioning element 222 securely clamping the rod 10 of the carrying frame 1 is loosened and then each movable seat 221 is moved away from each pivoting member 21. Eventually, each movable seat 221 is stopped and each positioning element 222 is securely clamped the rod 10 of the carrying frame 1 again when the position of the carrying frame 1 relative to the ground is appropriate for the road surface. Alternatively, above steps are repeated but each movable seat 221 is moved towards the pivoting member 21 to raise the position of the carrying frame 1 relative to the ground, as shown in FIG. 2.

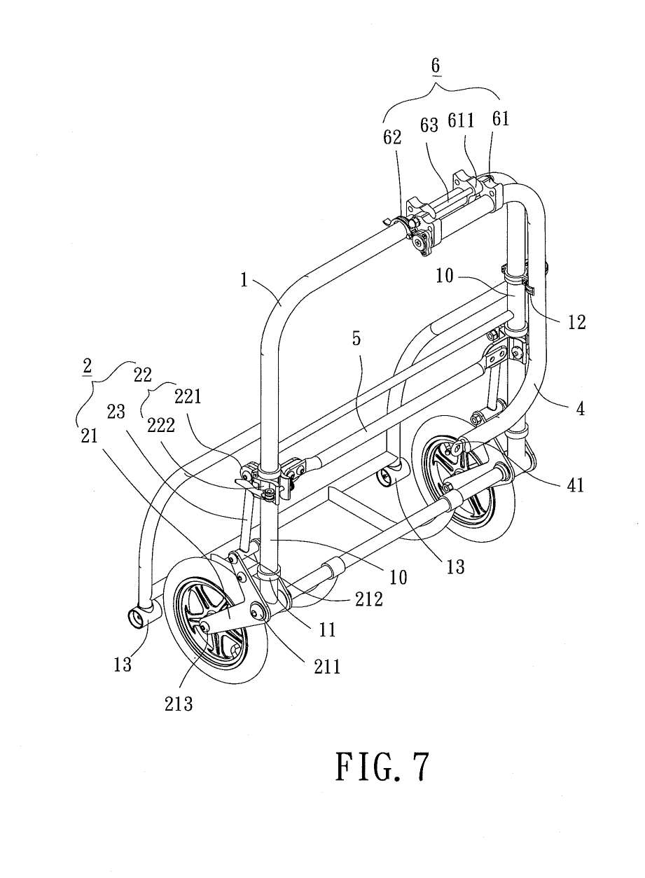

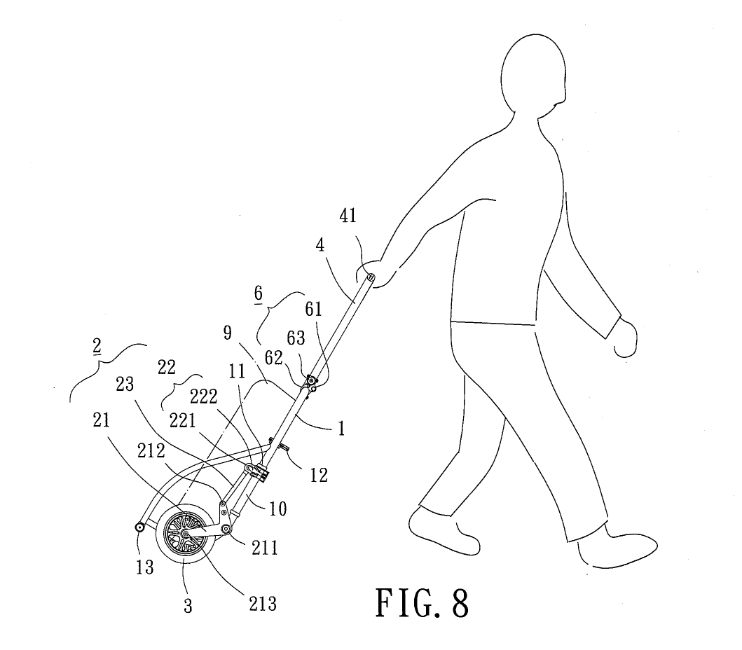

Referring now to FIG. 7, the linking arm 4 can be turned on the pin 63 to lap the linking arm 4 over the carrying frame 1, with an fixing element 12 fixed to the carrying frame 1 engaging with the linking arm 4, so that the linking arm 4 is securely positioned over the carrying frame 1. And each movable seat 221 is moved away from the pivoting member 22 and stopped at the retaining block 11, such that the bicycle trailer of the present invention is in a storing state for easy storage of the bicycle trailer. The carrying frame 1 further protrudes two skidproof elements 13 aligned with the two wheels 3, so that the bicycle trailer of the present invention is able to stand on the skidproof elements 13 and the wheels 3 for storing the bicycle trailer easily. Therefore, room that the bicycle trailer takes up is reduced. In addition, whether the linking arm 4 is lapped over the carrying frame 1 or not, the bicycle trailer of the present invention also can be used as a baggage barrow. As shown in FIG. 8, while the bicycle trailer of the present invention is in an unfolded state, namely the linking arm 4 not lapped over the carrying frame 1, a user can hold the linking arm 4 close to the linking portion 41 to directly drag the bicycle trailer to transport the baggage 9 without the bicycle. And the user can adjust positions of the wheels 3 relative to the carrying frame 1 for dragging easily and smoothly. Also, when the linking arm 4 is lapped over the carrying frame 1, the user can hold the rod of the carrying frame 1 close to the fastening module 6 to directly drag the bicycle trailer.

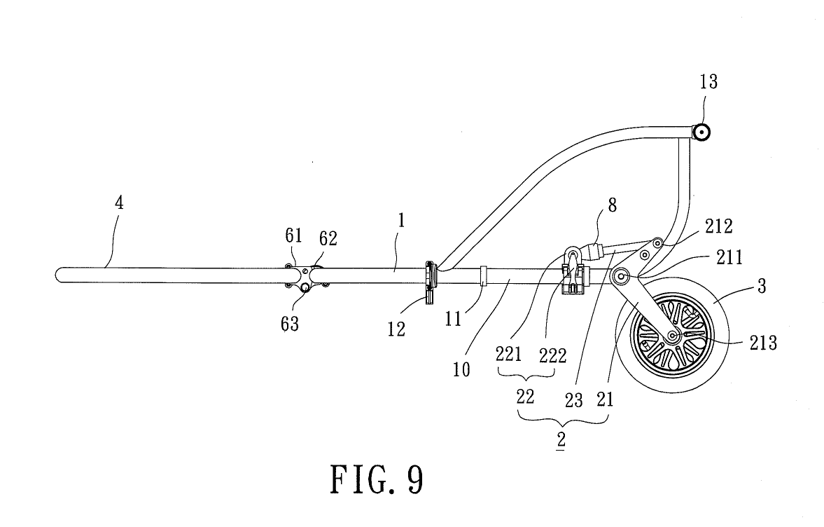

FIG. 9 shows a bicycle trailer of a second embodiment according to the preferred teachings of the present invention modified from the first embodiment, which further includes two shock absorbers 8. Each shock absorber 8 is mounted on the connecting bar 23 to smooth out or dampen shock impulse while the bicycle trailer travels over the rough ground, such that damage of the baggage 9 on the carrying frame 1 is avoided.

As has been discussed above, the positions of the wheels 3 relative to the carrying frame 1 can be adjusted by the adjusting modules 2 to change the distance between the carrying frame 1 and the ground. As a result, the bicycle trailer of the present invention indeed has several different uses.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A bicycle trailer, comprising:
a carrying frame adapted to hold objects;
two adjusting modules mounted at two opposite sides of the carrying frame respectively, with each adjusting module including a pivoting member pivotably coupled to a corner of the carrying frame, an adjusting member movably mounted on the carrying frame and aligned with the pivoting member to move close to or away from the pivoting member and a connecting bar with two ends thereof respectively fixed to the adjusting member and one end of the pivoting member; and
two wheels coupled to the other ends of the pivoting members of the two adjusting modules respectively.

2. The bicycle trailer as defined in claim 1, wherein the pivoting member is an L-shaped arm and a bent portion thereof forms a combining portion, with the combining portion being coupled to the corner of the carrying frame.

3. The bicycle trailer as defined in claim 2, wherein each pivoting member having a first end and a second end, with both first ends being fixed to the connecting bars and both second ends being fixed to axial centers of the two wheels.

4. The bicycle trailer as defined in claim 3, wherein each adjusting member has a movable seat movably mounted on a rod of the carrying frame, with the rods where the movable seats of the two adjusting modules mounted being at the two opposite sides of the carrying frame respectively, and a positioning element combing with the movable seat to fix the movable seat at a position on the rod of the carrying frame, with the connecting bar being fixed to the movable seat.

5. The bicycle trailer as defined in claim 1 further includes a linking arm coupled to the carrying frame, with the linking arm being at the front side of the carrying frame and the wheels being at the back side of the carrying frame.

6. The bicycle trailer as defined in claim 5, wherein the linking arm is a bent rod corresponding to the contour of the carrying frame and the linking arm has a linking portion on one end thereof adapted to be coupled to a bicycle.

7. The bicycle trailer as defined in claim 5 further includes a fastening module mounted between the linking arm and the carrying frame, with the linking arm being pivotably coupled to the carrying frame through the fastening module.

8. The bicycle trailer as defined in claim 7, wherein the fastening module has a plurality of rings with each of which forming a flange and a pin, with two adjacent rings being mounted around the carrying frame and the linking arm respectively, with flanges of the two adjacent rings being aligned with and attached to each other, with the pin extending through the attached flanges.

9. The bicycle trailer as defined in claim 8, wherein the fastening module further has a clasping element rotatably mounted on one end of the linking arm adjacent to the carrying frame, with the clasping element having a clasping portion selected from a C-loop which can engage with the carrying frame or not.

10. The bicycle trailer as defined in claim 2, wherein the L-shaped arm having an angle ranging 60° to 150°.

11. The bicycle trailer as defined in claim 4 further includes a connector with two ends thereof fixed to the movable seats of the adjusting modules respectively.

12. The bicycle trailer as defined in claim 1 further includes two shock absorbers with each of them mounted on the connecting bar.
